(19) United States
(12) Patent Application Publication
(10) Pub. No.: US 2007/0215640 A1
(43) Pub. Date: Sep. 20, 2007

(54) Dual product dispenser

(76) Inventor: Eddy Bitton, Westlake Village, CA (US)

Correspondence Address: CROCKETT & CROCKETT, 24012 CALLE DE LA PLATA, SUITE 400, LAGUNA HILLS, CA, 92653, US

(21) Appl. No.: 11/724,763

(22) Filed: Mar. 15, 2007

Related U.S. Application Data
(60) Provisional application No. 60/783,140, filed on Mar. 15, 2006.

(51) Int. Cl. B67D 5/52; B67D 5/56

(52) U.S. Cl. 222/135; 222/129

(57) ABSTRACT

A dual product dispenser may permit any two different consumer products to be stored, sold, dispensed and otherwise used from a single container without combining the products. To enhance product marketing, the consumer products may be complementary such as ketchup and mustard. The conjoined container may adopt any suitable geometry and generally includes a product dispenser opening, or apparatus at each end of the conjoined container for each product. The dual product dispenser may be oriented with either end up, supported by the other end.

### RELATED APPLICATIONS

This application claims the priority of copending U.S. Provisional Patent Application 60/783,140 filed Mar. 15, 2006.

### FIELD OF THE INVENTIONS

The inventions described below relate to the field of consumer product dispensers and more specifically to the field of conjoined dispensers for complementary consumer products.

### BACKGROUND OF THE INVENTIONS

Consumers increasingly seek convenience and efficiency when making purchasing decisions.

What is needed is a single container with a single container footprint for dispensing two or more complementary products from a single container.

### SUMMARY

A dual product dispenser may permit any two different consumer products to be stored, sold, dispensed and otherwise used from a container without combining the products. To enhance product marketing, the consumer products may be complementary such as ketchup and mustard, shampoo and conditioner, vinegar and oil etc. The separated container space, or conjoined container may adopt any suitable geometry and generally includes a product dispenser opening, or apparatus at opposing positions on the separated container for each product. The dual product dispenser may be oriented with either the first or second end up, supported by the second or first end respectively.

A dual product dispenser may also be configured with different dispenser apparatus for each product, the dispenser apparatus selected specifically for the product to be dispensed. The dispenser apparatus or cap or lid may be any suitable configuration or combinations of configurations. A simple screw-on lid or cap, a pour spout, a pump spout, foaming spout, a squeeze spout or any other suitable dispenser/cover apparatus may be used.

Suitable complementary products may be for example ketchup and mustard, olive oil and balsamic vinegar and or any other suitable products. Personal care items may also include for example toothpaste and mouthwash, shampoo and conditioner, shampoo and body wash and or any other suitable combinations. Where the relative volume of product used, for complimentary products varies, the relative volumes of the conjoined containers may be different. For example, a conjoined ketchup and mustard container may enclose 12 ounces of ketchup and 6 ounces of mustard.

The container may be formed of a single shell with a divider separating separate product volumes. Alternatively, two separate containers may be permanently joined along a complimentary interface forming an apparently single envelope or shell having two separate product volumes, each product volume having a dispensing port to engage any suitable dispensing apparatus. The product volumes may also be detachable.

### BRIEF DESCRIPTION OF THE DRAWINGS

FIG. 1 is a side view of dual product dispenser according to the present disclosure.

FIG. 2 is a side view of an alternate dual product dispenser according to the present disclosure.

### DETAILED DESCRIPTION OF THE INVENTIONS

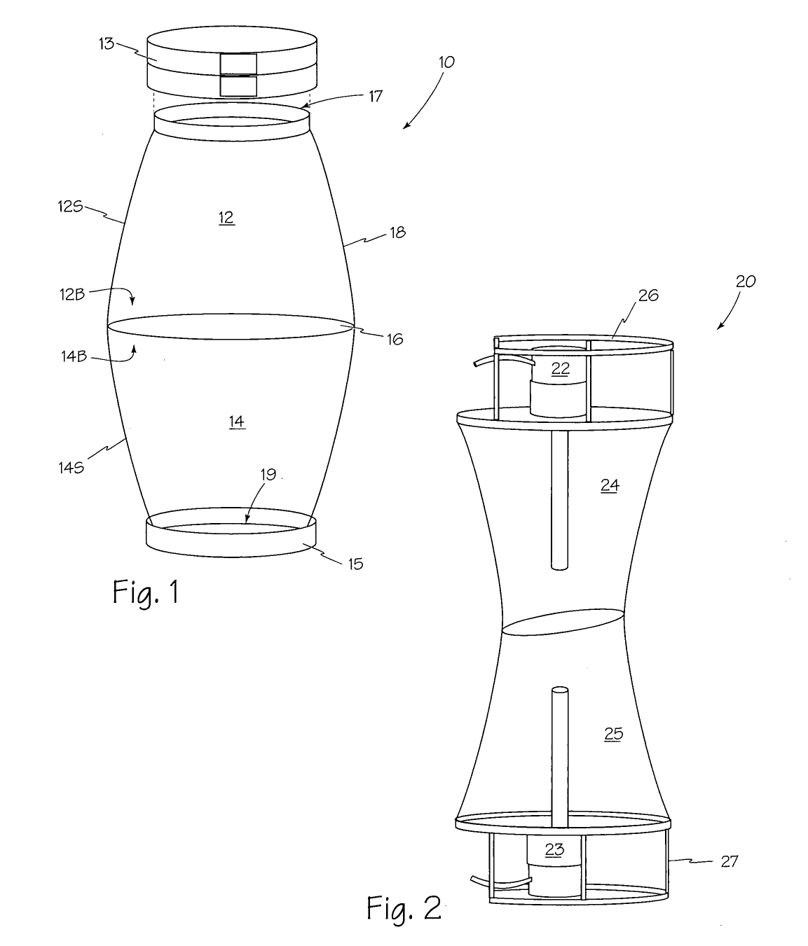

Dual product dispenser 10 as shown in FIG. 1 includes product shell 18 divided by partition 16 to form first product volume 12 having a dispenser port 17 closed by first cover 13, and second product volume 14 having a dispenser port 19 closed by second cover 15. Partition 16 may adopt any suitable shape or geometry to prevent mixing or cross-contamination between product volumes 12 and 14. Partition 16 may be located to provide similar product volumes or different product volumes. Covers 13 and 15 may be any suitable lid or cover and may also be reclosable. Covers 13 and 15 may be selected to enable dispenser 10 to be supported by cover 13 or cover 15 without spilling, leaking or otherwise inadvertently dispensing the contents of product volume 12 or product volume 14 respectively.

Alternatively, product shell 18 may be formed as a conjoined container with separate product shells such as shell 12S and shell 14S enclosing product volumes 12 and 14 respectively. The separate product shells may be joined or otherwise formed with base surfaces 12B and 14B in contact.

Dual product dispenser 20 of FIG. 2 may include any suitable apparatus for withdrawing the contents of a product volume such as pump dispenser 22 engaged to product volume 24. Using an apparatus such as a pump dispenser may also require suitable support such as supports 26 and 27. Support 27 may prevent unintended activation of secondary pump dispenser 23 when product dispenser 20 is supported by support 27. Different lids, caps, spouts, pumps or other suitable dispenser apparatus may be used on each dispenser port.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A dual product container comprising:
a container shell enclosing an internal volume between a first dispenser port and a second dispenser port;
an internal partition between the first and second dispenser ports separating the internal volume into a first and a second product container;
a removable first cover engaging the first dispenser port to enclose the first product container and permit dispensing from the first product container; and
a removable second cover engaging the second dispenser port to enclose the second product container and permit dispensing from the second product container.

2. The product dispenser of claim 1 wherein the removable first cover comprises:
a screw-on cap.

3. The product dispenser of claim 1 wherein the removable first cover comprises:
a pour spout.

4. The product dispenser of claim 1 wherein the removable first cover comprises:
a pump spout.

5. The product dispenser of claim 1 wherein the removable first cover comprises:
a squeeze spout.

6. The product dispenser of claim 1 wherein the first product container encloses a different volume than the second product container.

7. A product dispenser comprising:
a first product shell having a first dispenser port and a base, conjoined with a second product shell having a first dispenser port and a base, the conjoined shells engaged by their respective bases forming a dispenser shell;
a removable first cover engaging the first dispenser port to enclose the first product volume and permit dispensing from the first product shell; and
a removable second cover engaging the second dispenser port to enclose the second product volume and permit dispensing from the second product shell.

8. The product dispenser of claim 7 wherein the removable first cover and the removable second cover comprise:
a screw-on cap.

9. The product dispenser of claim 7 wherein the removable first cover and the removable second cover comprise:
a pour spout.

10. The product dispenser of claim 7 wherein the removable first cover and the removable second cover comprise:
a pump spout.

11. The product dispenser of claim 7 wherein the removable first cover and the removable second cover comprise:
a squeeze spout.

12. The product dispenser of claim 7 wherein the removable first cover and the removable second are different.

13. The product dispenser of claim 7 wherein the first product shell removably engages the second product shell.

14. The product dispenser of claim 7 wherein the first product shell permanently engages the second product shell.

15. The product dispenser of claim 7 wherein the first product shell encloses a different volume than the second product shell.
